(19) United States
(12) Patent Application Publication
(10) Pub. No.: US 2005/0144436 A1
(43) Pub. Date: Jun. 30, 2005

(54) Multitasking system level platform for HW/SW co-verification

(75) Inventors: Tse-Min Chen, Sindian City (TW); Chih-Lung Chang, Hualien County (TW)

Correspondence Address: BACON & THOMAS, PLLC, 625 SLATERS LANE, FOURTH FLOOR, ALEXANDRIA, VA, 22314, US

(73) Assignee: Institute for Information Industry, Taipei (TW)

(21) Appl. No.: 10/793,919

(22) Filed: Mar. 8, 2004

(30) Foreign Application Priority Data
Dec. 24, 2003 (TW) 092136736

(51) Int. Cl. G06F 1/24

(52) U.S. Cl. 713/100

(57) ABSTRACT

A multi-tasking system level Hw/Sw co-verification platform is disclosed. The platform comprises a verification hardware system including a replaceable processor core, a peripheral device required by an OS, a programming logic unit, and a SIP for implementing a complete system, a configurable hardware abstract layer for lowering a coupling with the verification hardware system in a lower level by means of an abstract description of hardware, a configurable device driver for driving hardware of the verification hardware system by means of the configurable hardware abstract layer, an OS for running on the verification hardware system so as to provide an environment and allowing applications to run thereon, and a configurable application for running functions of the verification hardware system.

### BACKGROUND OF THE INVENTION

1. Field of the Invention

The present invention generally relates to the technical field of SIP (silicon intellectual property) and, more particularly, to a multitasking system level platform for hardware/software co-verification developed for SIP.

2. Description of Related Art

Current embedded system design has entered into a system on-chip (SOC) age. For shortening time to market, conventionally, a platform based design is adopted in designing system hardware depending on application domains of products. Such platform based design further incorporates with one of a variety of IP (intellectual property) designs to achieve the required functions of a system. It is very important to successfully integrate the IP designs into the system in the above implementation in which the critical issue is the generation of interface between the system core and the IP.

With reference to FIG. 1, a prior approach of integrating a new IP into a system is illustrated. The first issue is how to deal with the interface circuit compatibility between the IP and OCB (on-chip bus) specifications. Widely used buses are AMBA of ARM, IBM core connect, open source Wishbone, etc. Typically for either processor core or IP, a bus wrapper is required for meeting the required bus transaction timing if a specific standard design is not pursued. Moreover, interfaces provided by IP are different depending on applications.

The second issue is that the communication between the processor core and surrounding IPs is achieved by protocols of three levels. Namely, the lowest bus transaction protocol, the intermediate data communication protocol, and the highest device driver. The intermediate data communication protocol is no longer related to the OCB specifications after being packaged by the bus wrapper. The intermediate data communication protocol may be implemented as single read/write, buffered FIFO (first-in-first-out) read/write, streaming data transfer, DMA (direct memory access) data transfer, shared memory communication, or the like. Some protocols are closely related with hardware resources of the platform such as DMA or FIFO.

Finally, for verifying the cooperative software, it is required to write drivers based on a protocol defined by RTOS (real-time operating system) specifications. That is, the steps comprises designing hardware, writing a simplex software to test functions of the verified hardware, performing the design if the test is successful, and porting an OS (operating system) on the chip. However, at this time it is impossible of modifying hardware on the chip if either the total system performance is low or even there is defect. Thus, it is required to reproduce the chip, resulting in an increase of the development cost and a delay of chip production.

Another method involves cooperatively simulating a utility by expensive hardware and software and simultaneously performing circuit simulation and software simulation on a typical computer or workstation. However, such method has a very low speed. For example, several hours are required for simulating booting, resulting in a low performance. Also, there is timing difference between the simulation result and the verified circuit. A further adjustment is thus required.

For solving the above problem, U.S. patent publication 2000/519659 discloses a mathematical algorithm to establish a hardware and software model which is in turn used to simulate hardware and software behavior of the system. This is a more accurate simulation than a method of using a single mathematical model in simulation. However, such a system simulation can neither correctly simulate the real condition of system nor simulate the real timing.

Furthermore, U.S. patent publication 2001/820876 discloses a hardware verification method and tool by integrating hardware and software co-verification. It has an increased speed and efficiency in system verification. However, it does not take factors of software running on a test chip and other system components into consideration in the system level.

In addition, U.S. patent publication 2000/494907 discloses a hardware and software co-verification method involving re-usable software including applications and drivers, generating test signals, feeding the test signals to a circuit to be tested, and verifying the result from output signals of the circuit to be tested. It is advantageous for taking the factor of the integrated hardware and software co-verification into consideration. However, for software it does not take interface between OS and driver in the lowest level into consideration when the circuit to be tested is integrated into a system. Thus, a correct verification of system performance is made impossible.

Therefore, it is desirable to provide a novel hardware and software cooperative verification system in order to mitigate and/or obviate the aforementioned problems.

### SUMMARY OF THE INVENTION

The object of the present invention is to provide a multi-tasking system level platform for Hw/Sw co-verification so as to simultaneously verify hardware and an interaction with the whole system.

To achieve the object, there is provided multi-tasking system level platform for Hw/Sw co-verification for providing a synchronous verification environment for hardware and software design so as to verify an interaction of hardware and software with the whole system. The platform comprises a verification hardware system, a configurable hardware abstract layer, a configurable device driver, a operation system and a configurable application program. The verification hardware system includes a replaceable processor core, a peripheral device required by the OS, a programming logic unit, and a SIP for implementing a complete system; the configurable hardware abstract layer for lowering coupling with the verification hardware system in a lower level by means of an abstract description of hardware; the configurable device driver for driving the verification hardware system by means of the configurable hardware abstract layer; the OS for running on he verification hardware system so as to provide an environment and allowing applications to run thereon; and the configurable application for running functions of the verification hardware system.

Other objects, advantages, and novel features of the present invention will become more apparent from the detailed description when taken in conjunction with the accompanying drawings.

### BRIEF DESCRIPTION OF THE DRAWINGS

FIG. 1 is a block diagram of a conventional development system for SIP;

FIG. 2 is a block diagram of a multi-tasking system level hw/sw co-verification platform in accordance with the present invention;

FIG. 3 is a block diagram of a verification hardware system in accordance with the present invention;

FIG. 4 is a block diagram of fixed hardware circuit in accordance with the present invention;

FIG. 5 is a block diagram of monitor in accordance with the present invention;

FIG. 6 is a block diagram of virtual function component in accordance with the present invention;

FIG. 7 is a block diagram of configurable hardware abstract layer in accordance with the present invention;

FIG. 8 is a block diagram of configurable device driver in accordance with the present invention; and

FIG. 9 is a flow chart of the multi-tasking system level hw/sw co-verification platform in accordance with the present invention.

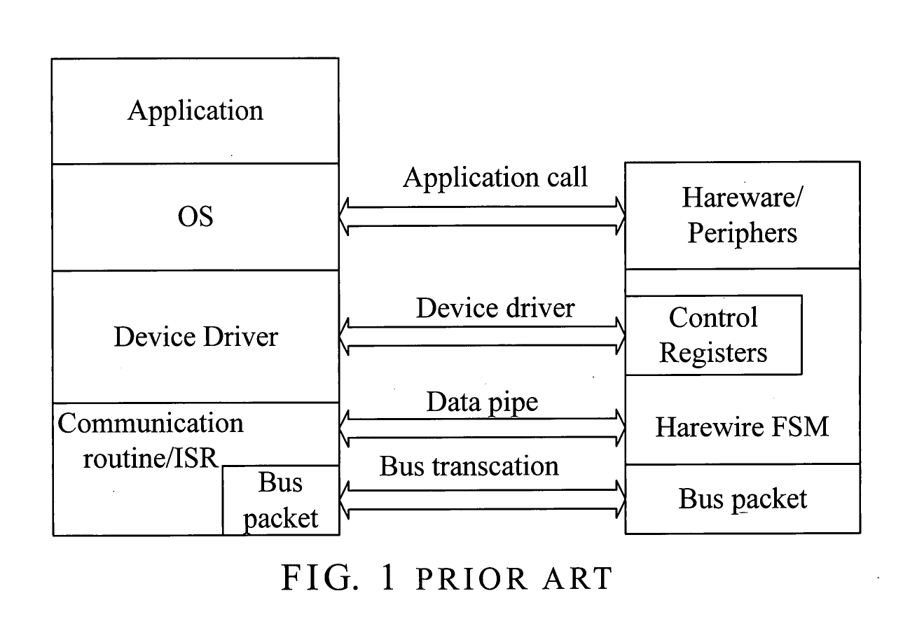

### DETAILED DESCRIPTION OF THE PREFERRED EMBODIMENT

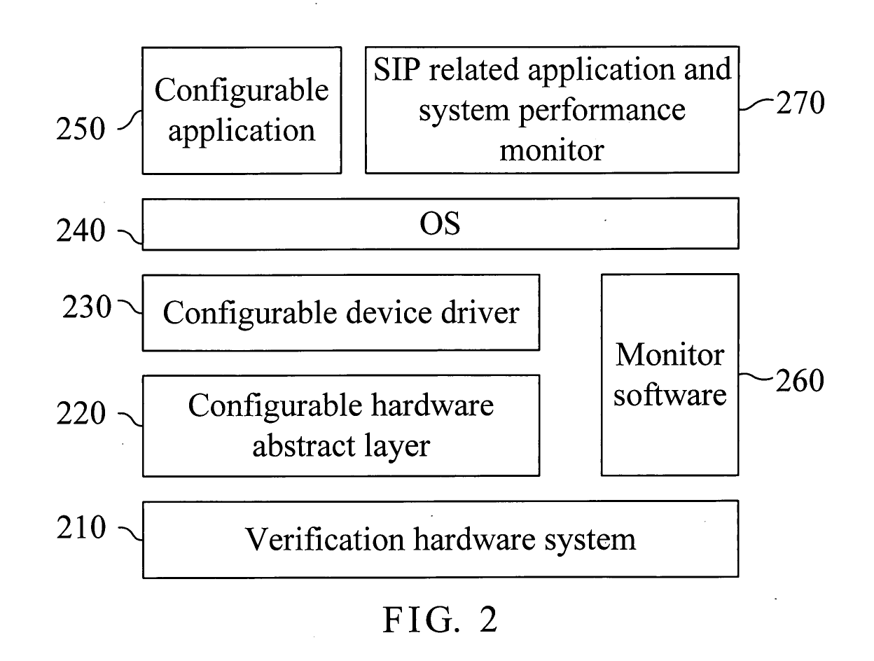

With reference to FIG. 2, there is shown a block diagram of a preferred embodiment of a multi-tasking system level platform for Hw/Sw co-verification in accordance with the present invention. The platform is adapted to provide a synchronous verification environment for hardware and software design so as to verify the interaction of hardware and software with the whole system. The platform comprises a verification hardware system 210, a configurable hardware abstract layer 220, a configurable device driver 230, an OS 240, a configurable application 250, a monitor software 260, and a SIP related application and system performance monitor 270. Each component will be described in detail below.

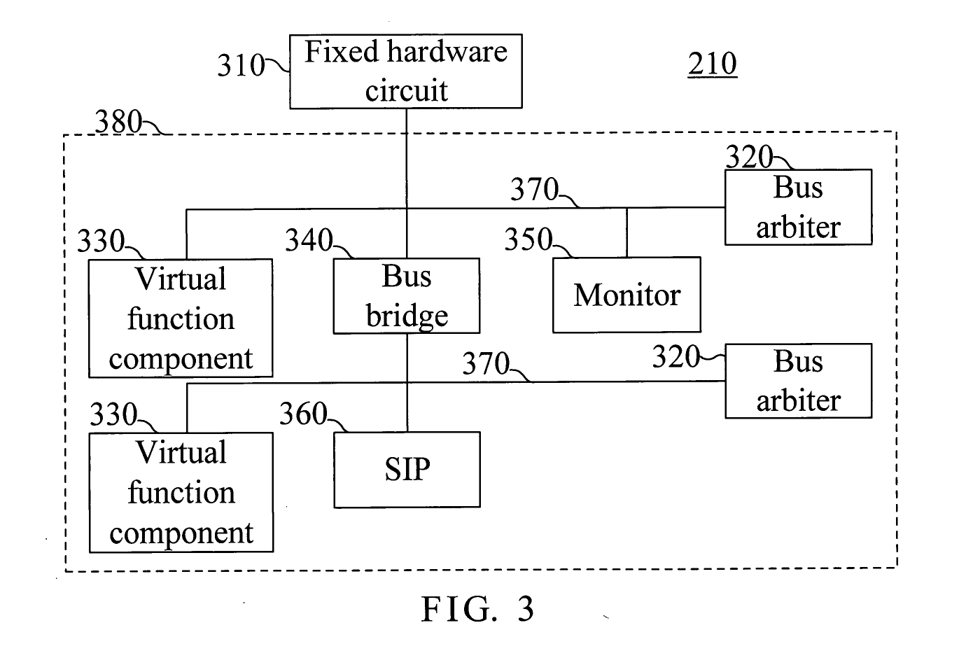

With reference to FIG. 3, there is shown a block diagram of the verification hardware system 210. The verification hardware system 210 comprises a fixed hardware circuit 310 and a programming logic unit 380. The programming logic unit 380 is implemented as a FPGA, CPLD, or an array including a plurality of FPGAs, and the programming logic unit 380 comprises a bus arbiter 320, a virtual function component (VFC) 330, a bus bridge 340, a monitor 350, a SIP 360, and a bus 370.

The SIP 360 is a circuit designed by a developer and is to be verified. The SIP 360 can be written by HDL (hardware description language) based VHDL or Verilog. The written SIP 360 is then synthesized by a synthesizer and placed and routed by a P&R tool for generating a circuit file representing the circuit. Finally, the file is downloaded to the programming logic unit 380 for forming a circuit to be verified. The VFC 330 is generated automatically for simulating the system resource requirements of other peripheral devices of the system so that the real circuit can be simulated.

Parameters of the bus arbiter 320, the bus bridge 340, and the monitor 350 can be set by IP designers so as to automatically generate the bus arbiter 320 and the bus bridge 340. The bus arbiter 320 is adapted to arbitrate an access order and priority of the bus 370. The bus 370 is implemented as an AMBA bus or a PI bus. The bus bridge 340 is connected between the SIP 60 and the bus 370. The monitor 350 is adapted to monitor the SIP 360 and the consumption of resources.

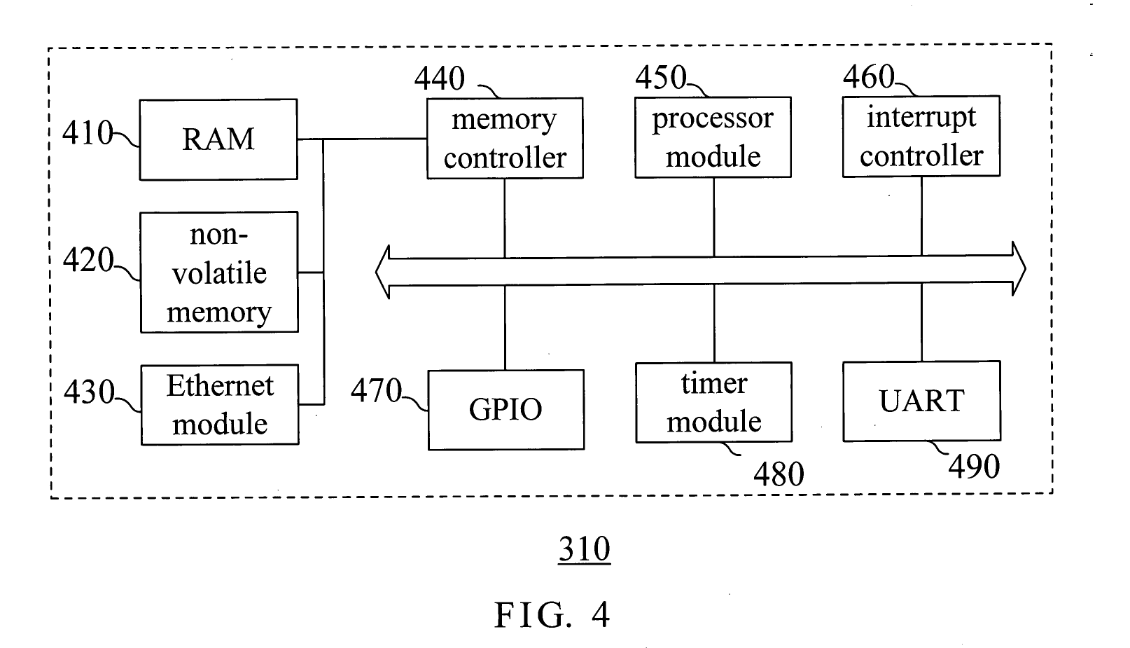

With reference to FIG. 4, there is shown a block diagram of the fixed hardware circuit 310. The fixed hardware circuit 310 comprises a RAM (random access memory) 410, a non-volatile memory 420, an Ethernet module 430, a memory controller 440, a processor module 450, an interrupt controller 460, a general I/O (input/output) port (GPIO) 470, a timer module 480, and a UART (universal asynchronous receiver transceiver) 490. The SIP 360 can be run by OS thereof only when the fixed hardware circuit 310 comprises the above components. As a result, the system performance monitor software can be run correctly.

The processor module 450 is adapted to select an appropriate processor core such as prior ARM7, ARM9, ARM9TDMI, or MIPS, or one developed by itself depending on design requirements. The non-volatile memory 420 is implemented as a flash memory for storing the OS 240, the configurable application 250, the device driver, and related applications so as to perform the hardware and software co-verification. The non-volatile memory 420 is also adapted to store circuit files of the SIP 360 so that the circuit file can be downloaded to the programming logic unit 380. The RAM 410 is adapted to store the OS 240, the configurable application 250, the device driver, and related applications while running.

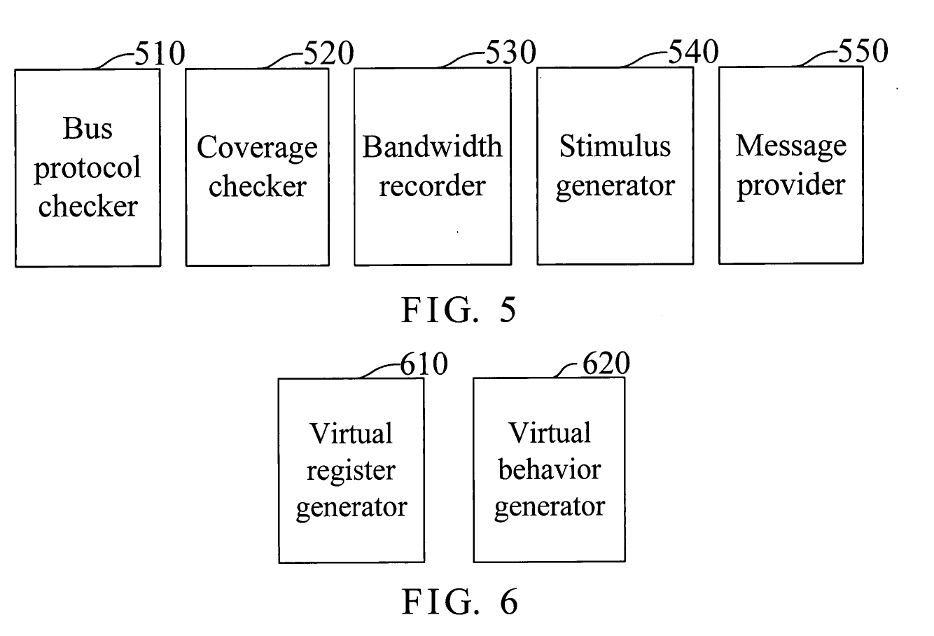

With reference to FIG. 5, there is shown a block diagram of the monitor 350. The monitor 350 is comprised of a bus protocol checker 510, a coverage checker 520, a bandwidth recorder 530, a stimulus generator 540, and a message provider 550. The bus protocol checker 510 is adapted to check the correctness of protocol being used for transferring data over the bus 370. The coverage checker 520 is adapted to check the coverage of algorithm of user IP. The bandwidth recorder 530 is adapted to record and analyze the bandwidth being used on the bus. The stimulus generator 540 is adapted to generate test signals. The message provider 550 is adapted to record the monitor data and send back the same.

With reference to FIG. 6, there is shown a block diagram of the VFC 330. The VFC 330 is comprised of a virtual register generator 610 and a virtual behavior generator 620. The virtual register generator 610 is adapted to generate registers (e.g., RX/TX register or status register) required by the VFC 330. The virtual behavior generator 620 is adapted to simulate behaviors (e.g., period of time of transferring or receiving data and whether an interrupt is occurred) of the VFC 330.

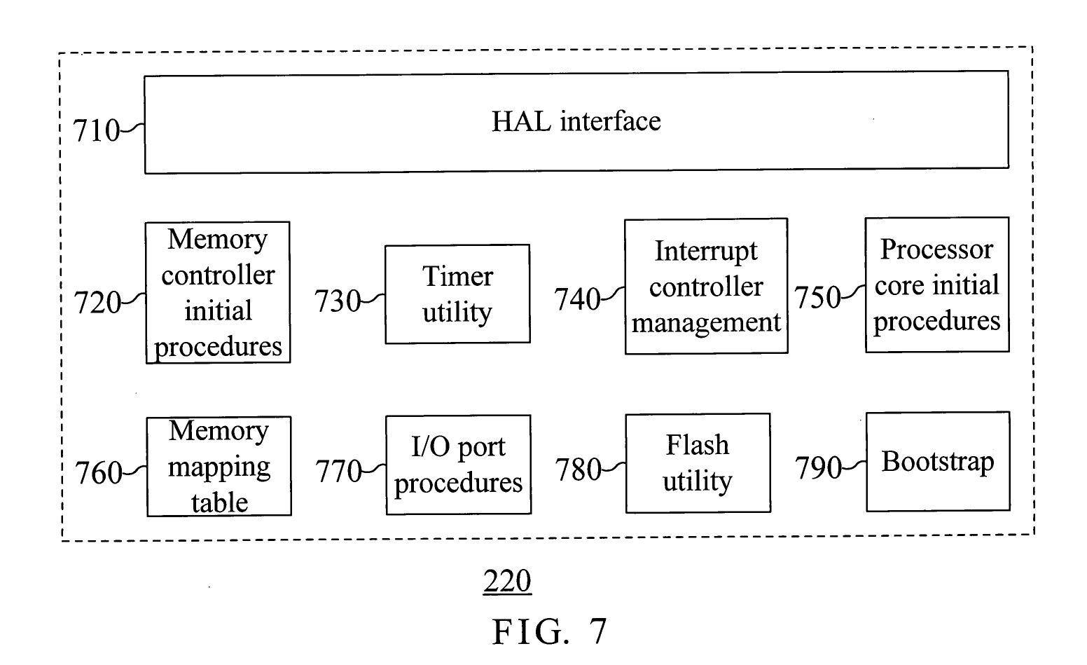

With reference to FIG. 7, there is shown a block diagram of the configurable hardware abstract layer 220 which comprises a HAL interface 710, memory controller initial procedures 720, a timer utility 730, an interrupt controller management 740, processor core initial procedures 750, a memory mapping table 760, I/O port procedures 770, a flash utility 780, and a bootstrap 790.

The memory mapping table 760 comprise a plurality of entries each representing a parameter (e.g., definition of memory mapping address of each hardware component) set by a user by means of utility so as to automatically generate a program definition file (e.g., .h include file). The I/O port functions 770 correspond mapping address I/O functions of low level memory of the memory mapping table 760. The flash utility 780 is adapted to access low level library of the non-volatile memory 420. The bootstrap 790 is adapted to initialize the system, configure memory, configure stacks, test hardware, and load OS when powering on.

The timer utility 730 is adapted to provide timer initialization, set, reset, time access, and timer interrupt registration. The interrupt controller management 740 is adapted to provide interrupt priority management, interrupt interface to the processor module 450, interrupt management of the fixed hardware circuit 310, and interrupt expansion interface of all components of the programming logic unit 380. The processor core initial codes 750 are associated with initialization of the processor module 450 and interrupt vector setting and configuration so that the OS can run normally.

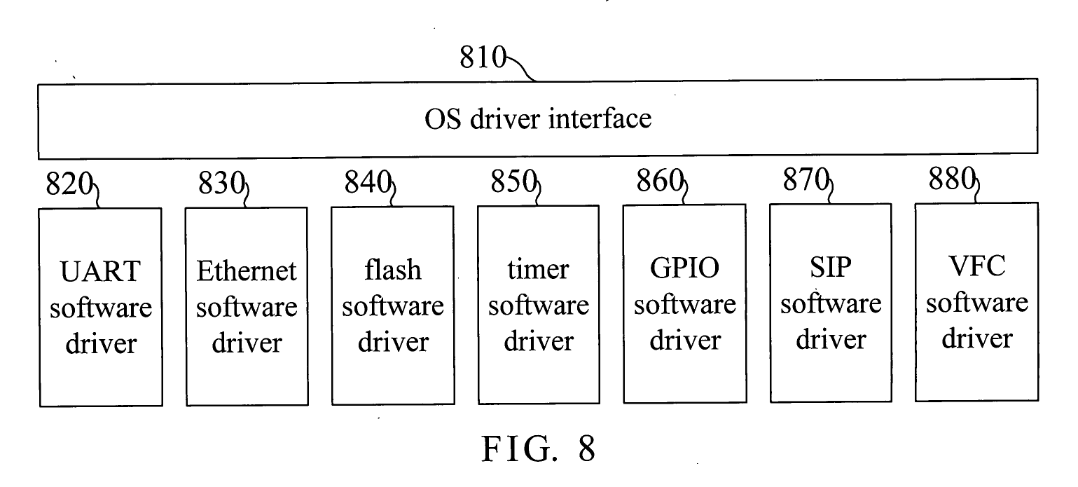

With reference to FIG. 8, there is shown a block diagram of the configurable device driver 320 that comprises an OS driver interface 810, a UART software driver 820, an Ethernet software driver 830, a flash software driver 840, a timer software driver 850, a GPIO software driver 860, a SIP software driver 870, and a VFC software driver 880.

The configurable device driver 320 is adapted to verify drivers including UART driver, Ethernet driver, flash driver, timer driver, and GPIO driver of the fixed hardware circuit 310 of the verification hardware system. Hence, a user can set configuration by means of utility. And in turn, the utility can automatically modify samples and generate driver.

The driver of the SIP 360 is one complying with a driver sample required by OS. Hence, a user can set configuration by means of utility. And in turn, the utility can automatically modify samples and generate driver. The driver of the VFC 330 is also one complying with a driver sample required by OS. Hence, a user can set configuration by means of utility. And in turn, the utility can automatically modify samples and generate a driver of the VFC 330.

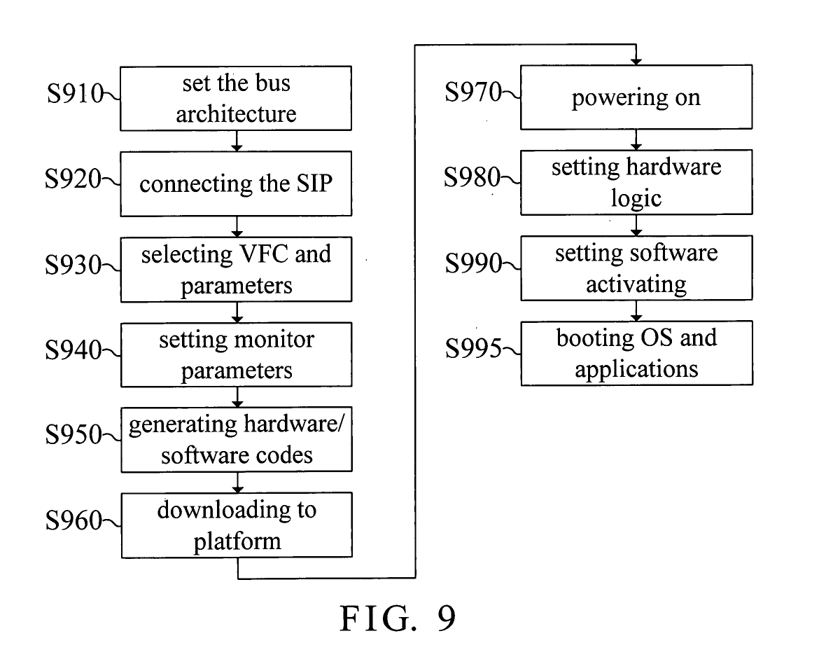

With reference to FIG. 9, there is shown a process performed by the multiplex hardware and software cooperative verification system in accordance with the present invention. The process comprises the steps of using a utility to set the bus 370 architecture (step S910), connecting the SIP 360 to the bus 370 (step S920), selecting the VFC 330 and setting required resource parameters (step S930), using a utility to set monitor parameters (step S940), generating hardware/software codes (step S950), compiling the software codes, linking the same as an executable file, synthesizing the hardware/software codes with P&R to create a hardware file, and downloading the file to the hardware platform (step S960), powering on the multi-tasking system level Hw/Sw co-verification platform of the present invention (step S970), setting hardware logic (step S980), setting software activating (step S990), and booting OS and applications (step S995). At this time, a multi-tasking system level hardware and software co-verification can be performed.

Although the present invention has been explained in relation to its preferred embodiment, it is to be understood that many other possible modifications and variations can be made without departing from the spirit and scope of the present invention as hereinafter claimed.

1. A multi-tasking system level Hw/Sw co-verification platform for providing a synchronous verification environment for hardware and software design so as to verify an interaction of hardware and software with the whole system, the platform comprising:
a verification hardware system including a replaceable processor core, a peripheral device required by an OS, a programming logic unit, and a SIP for implementing a complete system;
a configurable hardware abstract layer for lowering coupling with the verification hardware system in a lower level by means of an abstract description of hardware;
a configurable device driver for driving hardware of the verification hardware system by means of the configurable hardware abstract layer;
an OS for running on the verification hardware system so as to provide an environment and allowing applications to run thereon; and
a configurable application for running functions of the verification hardware system.

2. The platform as claimed in claim 1, wherein the verification hardware system is operative to set parameters for generating a bus arbiter, a bridge, and a monitor.

3. The platform as claimed in claim 2, wherein the monitor is operative to monitor behavior of the SIP and resources.

4. The platform as claimed in claim 2, wherein the bus arbiter is operative to arbitrate an access order of a bus.

5. The platform as claimed in claim 4, wherein the bus is an AMBA bus.

6. The platform as claimed in claim 4, wherein the bus is a PI bus.

7. The platform as claimed in claim 2, wherein the bridge is connected between the SIP and the bus.
